(19) United States
(12) Patent Application Publication
(10) Pub. No.: US 2023/0179942 A1
(43) Pub. Date: Jun. 8, 2023

(54) AUDIO-BASED VISUAL ORIENTATION IN A USER-PERCEIVED ENVIRONMENT

(71) Applicant: AT&T Intellectual Property I, L.P., Atlanta, GA (US)

(72) Inventors: Richard Palazzo, Stewartsville, NJ (US); Brian M. Novack, St. Louis, MO (US); Rashmi Palamadai, Naperville, IL (US); Tan Xu, Bridgewater, NJ (US); Eric Zavesky, Austin, TX (US); Ari Craine, Marietta, GA (US); Robert Koch, Peachtree Corners, GA (US)

(21) Appl. No.: 17/541,030

(22) Filed: Dec. 2, 2021

(51) Int. Cl. H04S 7/00; G01S 19/42

(52) U.S. Cl. CPC H04S 7/304; H04S 2400/11; G01S 19/42

(57) ABSTRACT

The technology described herein is generally directed towards the use of spatial audio to provide directional cues to assist a user in looking in a desired direction in a user perceived environment, which can be a real-world or a virtual environment. Location data for a user in three-dimensional space can be obtained. A direction of view of the user within the user-perceived environment is determined. Spatial audio can be output that is perceived as coming from a position within the user-perceived environment, such as to provide directional cues directed to changing the direction of view of the user to a different view. The spatial audio can provide prompts to the user to adjust his or her vision towards the desired direction, for example. The user's location and direction of view can be mapped to audio that is relevant to the user's direction of view when at that location.

### TECHNICAL FIELD

The subject application relates to the presentation of audio information in general, and more particularly to using spatial audio to direct a user's view.

### BACKGROUND

A user may be attempting to experience something in an environment and may be in need of orientation of the direction of his or her field of view. For example, consider a user in a real-world environment on an audio-guided tour, with the audio received through headphones. The user may be experiencing the tour from various locations while on an observation deck, while on a helicopter ride, while riding on a gondola, and so forth. The tour may be more enjoyable and informative if a user directs his or her vision in the correct direction, or towards a certain location. For example, if the audio tour is describing the architecture of a historical building but the user is looking elsewhere, the user can become confused or be misinformed, based on what the user is actually viewing, by the audio.

Likewise, it may be desirable to direct a user's visual attention to see a certain element presented within a virtual environment, such as a virtual reality environment.

### BRIEF DESCRIPTION OF THE DRAWINGS

Non-limiting and non-exhaustive embodiments of the subject disclosure are described with reference to the following figures, wherein like reference numerals refer to like parts throughout the various views unless otherwise specified.

FIG. 1 is an example representation of a user in an environment in which the user is to be directed to change his or her view, in accordance with various aspects and embodiments of the subject disclosure.

FIGS. 2 and 3 are example representations of determining a user's current view direction and location, in accordance with various aspects and embodiments of the subject disclosure.

FIG. 4 is an example representation of determining a user's current view direction including azimuth and altitude data, in accordance with various aspects and embodiments of the subject disclosure.

FIGS. 5A-5C are example representations of using spatial audio to redirect a user's view direction, as well as to match audio content to the view direction, in accordance with various aspects and embodiments of the subject disclosure.

FIG. 6 is an example representation of using spatial audio to more finely adjust a user's view direction, in accordance with various aspects and embodiments of the subject disclosure.

FIG. 7 is a flow diagram of example operations related to determining orientation settings for presentation of spatial audio content to a user, in which the spatial audio content is related to a user view direction, in accordance with various aspects and embodiments of the subject disclosure.

FIG. 8 is a flow diagram of example operations related to determining orientation settings for presentation of spatial audio content to a user, in which the spatial audio content is related to a user view direction and location in a real-world environment, in accordance with various aspects and embodiments of the subject disclosure

FIG. 9 is a flow diagram representing example operations related to obtaining location and first view direction data of a user and using that data to change the first view direction to a second view direction, in accordance with various aspects and embodiments of the subject disclosure.

FIG. 10 illustrates an example block diagram of an example mobile handset operable to engage in a system architecture that facilitates wireless communications according to one or more embodiments described herein.

FIG. 11 illustrates an example block diagram of an example computer/machine system operable to engage in a system architecture that facilitates wireless communications according to one or more embodiments described herein.

### DETAILED DESCRIPTION

The technology described herein is generally directed towards the use of spatial audio to provide directional visual cues to assist a user in looking in a desired direction in a user perceived environment, which can be a real-world environment or a virtual environment. The spatial audio can provide prompts to the user to adjust his or her vision towards the desired direction, for example.

In one implementation, the user's actual direction of vision is determined in three-dimensional space. Based on the direction of vision and the user's sensed location in an environment, for example, where the user is looking at can be determined to a reasonably precise estimate. Geographical data can be mapped to this view, and used to determine what audio content to output. For example, the audio can describe a building the user is currently looking at. The audio can guide the user to look elsewhere (e.g., “look more left and you will see . . . ”). Moreover, spatial audio allows the user to perceive the audio as coming from different locations. A prompt from behind the user can guide the user to turn around, for example.

As used in this disclosure, in some embodiments, the terms “component,” “system” and the like are intended to refer to, or include, a computer-related entity or an entity related to an operational apparatus with one or more specific functionalities, wherein the entity can be either hardware, a combination of hardware and software, software, or software in execution. As an example, a component may be, but is not limited to being, a process running on a processor, a processor, an object, an executable, a thread of execution, computer-executable instructions, a program, and/or a computer. By way of illustration and not limitation, both an application running on a server and the server can be a component.

One or more components may reside within a process and/or thread of execution and a component may be localized on one computer and/or distributed between two or more computers. In addition, these components can execute from various computer readable media having various data structures stored thereon. The components may communicate via local and/or remote processes such as in accordance with a signal having one or more data packets (e.g., data from one component interacting with another component in a local system, distributed system, and/or across a network such as the Internet with other systems via the signal). As another example, a component can be an apparatus with specific functionality provided by mechanical parts operated by electric or electronic circuitry, which is operated by a software application or firmware application executed by a processor, wherein the processor can be internal or external to the apparatus and executes at least a part of the software or firmware application. As yet another example, a component can be an apparatus that provides specific functionality through electronic components without mechanical parts, the electronic components can include a processor therein to execute software or firmware that confers at least in part the functionality of the electronic components. While various components have been illustrated as separate components, it will be appreciated that multiple components can be implemented as a single component, or a single component can be implemented as multiple components, without departing from example embodiments.

Further, the various embodiments can be implemented as a method, apparatus or article of manufacture using standard programming and/or engineering techniques to produce software, firmware, hardware or any combination thereof to control a computer to implement the disclosed subject matter. The term “article of manufacture” as used herein is intended to encompass a computer program accessible from any computer-readable (or machine-readable) device or computer-readable (or machine-readable) storage/communications media. For example, computer readable storage media can include, but are not limited to, magnetic storage devices (e.g., hard disk, floppy disk, magnetic strips), optical disks (e.g., compact disk (CD), digital versatile disk (DVD)), smart cards, and flash memory devices (e.g., card, stick, key drive). Of course, those skilled in the art will recognize many modifications can be made to this configuration without departing from the scope or spirit of the various embodiments.

Moreover, terms such as “mobile device equipment,” “mobile station,” “mobile,” subscriber station,” “access terminal,” “terminal,” “handset,” “communication device,” “mobile device” (and/or terms representing similar terminology) can refer to a wireless device utilized by a subscriber or mobile device of a wireless communication service to receive or convey data, control, voice, video, sound, gaming or substantially any data-stream or signaling-stream. The foregoing terms are utilized interchangeably herein and with reference to the related drawings. Likewise, the terms “access point (AP),” “Base Station (BS),” BS transceiver, BS device, cell site, cell site device, “gNode B (gNB),” “evolved Node B (eNode B),” “home Node B (HNB)” and the like, can be utilized interchangeably in the application, and can refer to a wireless network component or appliance that transmits and/or receives data, control, voice, video, sound, gaming or substantially any data-stream or signaling-stream from one or more subscriber stations. Data and signaling streams can be packetized or frame-based flows.

Furthermore, the terms “user equipment,” “device,” “communication device,” “mobile device,” “subscriber,” “customer entity,” “consumer,” “customer entity,” “entity” and the like may be employed interchangeably throughout, unless context warrants particular distinctions among the terms. It should be appreciated that such terms can refer to human entities or automated components supported through artificial intelligence (e.g., a capacity to make inference based on complex mathematical formalisms), which can provide simulated vision, sound recognition and so forth.

Embodiments described herein can be exploited in substantially any wireless communication technology, including, but not limited to, wireless fidelity (Wi-Fi), global system for mobile communications (GSM), universal mobile telecommunications system (UMTS), worldwide interoperability for microwave access (WiMAX), enhanced general packet radio service (enhanced GPRS), third generation partnership project (3GPP) long term evolution (LTE), third generation partnership project 2 (3GPP2) ultra mobile broadband (UMB), high speed packet access (HSPA), Z-Wave, Zigbee and other 802.11 wireless technologies and/or legacy telecommunication technologies.

One or more embodiments are now described with reference to the drawings, wherein like reference numerals are used to refer to like elements throughout. In the following description, for purposes of explanation, numerous specific details are set forth in order to provide a thorough understanding of the various embodiments. It is evident, however, that the various embodiments can be practiced without these specific details (and without applying to any particular networked environment or standard).

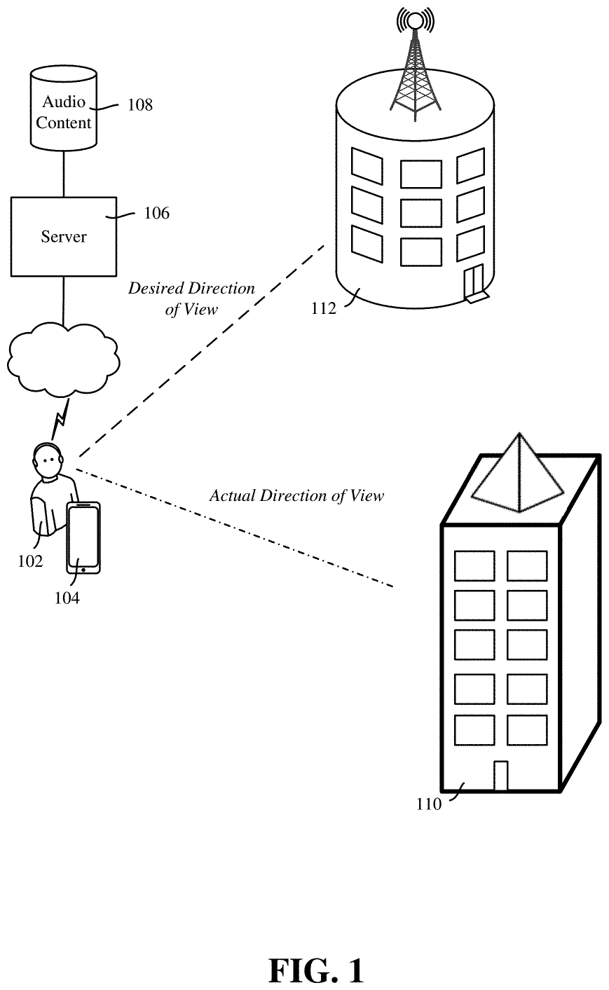

FIG. 1 is a representation of a user 102 experiencing a real-world or virtual environment who is in need of directional navigation instructions regarding the user's current view. That is, the user 102 may be in need of or desire to receive instructions on how to adjust the direction of their vision while either moving or stationary within the environment. Note that the user can also be given instructions on direction of travel within the environment, if appropriate. In the example of FIG. 1, the user is carrying a smartphone 104 (or is equipped in some way to provide location data) to a server 106, which in turn can send audio content from an audio content data store 108 to the user 102. The audio data from the server 106 can be transmitted in any suitable way to earphones/headphones worn by the user, including by indirect transmission via the smartphone or the like 104. It is feasible to use spatial audio to ensure the user's headphones or the like are being worn correctly, “if you hear this from the left, your headphones are on backwards” or some similar guidance. It is also feasible to steer audio from more distant speakers to a user, such that if the direction of view of a user can be otherwise determined without headwear, e.g., via cameras or other sensors, the technology including spatial audio as described herein can be used with speakers more distant than headphone/ear speakers, based on the user's current view.

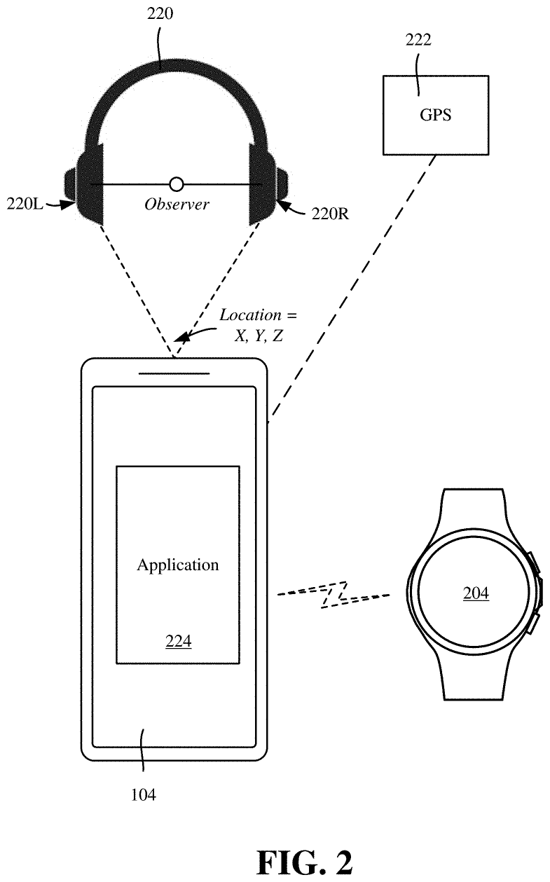

Thus, using an example of the user 102 experiencing an audio guided travel tour, the example user 102 in FIG. 1 is equipped with earphones, headphones 220 (FIG. 2) or the like that are capable of presenting audio content to the user, including devices that are spatial audio capable. In the example of FIG. 1, the user is looking at an actual or virtually output building 110 (actual direction of view), however the user is supposed to be reorienting his or her line of sight to a different building 112 (desired direction of view).

With respect to detection of the user's direction of view, as shown in FIG. 2, a user may be equipped with a mobile device such as a smartphone (e.g., the smartphone 104 of FIG. 1), a smartwatch 204, and/or other wearable or implantable device. The device may be location aware through a technology such as GPS 222, or be able to have an otherwise determinable location, such as based on known fixed locations such as cell towers, beacons, or others. In this way, the device 104 and/or 204 can know its own location, point (X, Y, Z), in three-dimensional (3D) space. Note that it is feasible for a user to be fixed within a location, such as sitting in a chair in a virtual environment, in which event the X, Y, Z location of the user is not as significant (and may be irrelevant) with respect to directing the user's view. Notwithstanding, a user can generally move about in a virtual environment, in which case the X, Y, Z location within the virtual environment may be significant.

The device(s) 104 and/or 204 may also be paired with or otherwise in communication with the headphones 220, such as via an application program 224. Moreover, the device may be in communication with the left speaker 220L and right speaker 220R separately. This communication may be for the presentation of audio content but may also be used to orient the left and right speakers with respect to the known point location (X, Y, Z), of the device. The determination of the location of points 220L and 220R in 3D space (the locations in space of the speakers) may be made based on accelerometer and gyroscope sensor readings made by the headphones 220, for example.

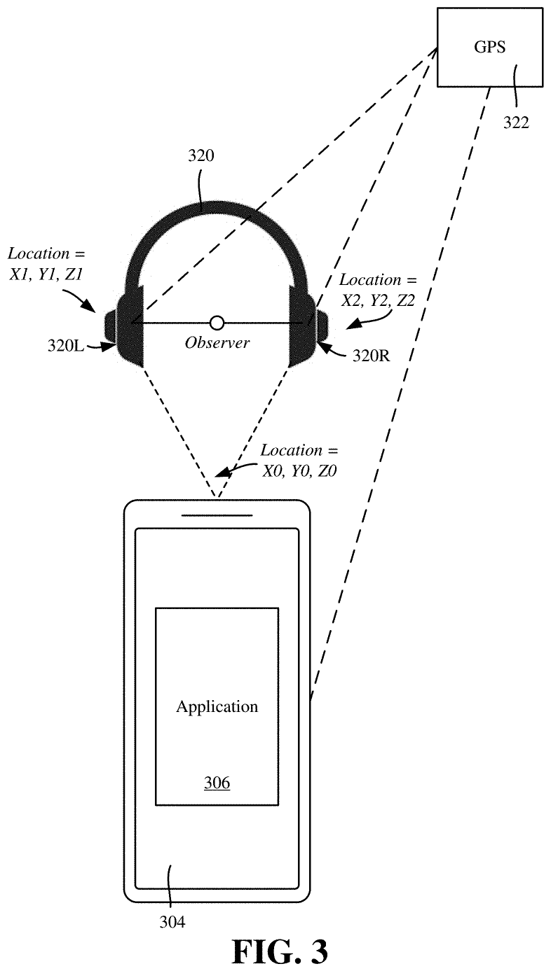

Alternatively, as shown in FIG. 3, on a different type of headset 320 the left and right speakers 320L and 320R both may be independently location aware through similar technologies such as GPS, beacons, or other technologies. In this alternative manner, the locations of the device 304 and the left and right speakers 320L and 320R may be determined within 3D space, e.g., (represented in FIG. 3 as [X0, Y0, Z0], [X1, Y1, Z1] and [X2, Y2, Z2], respectively).

Whether the alternative in the example of FIG. 2 or FIG. 3 is used, the location of the left and right speakers within x, y, z coordinates may be determined. The midpoint of the speaker locations may be determined to be the observer location of the user.

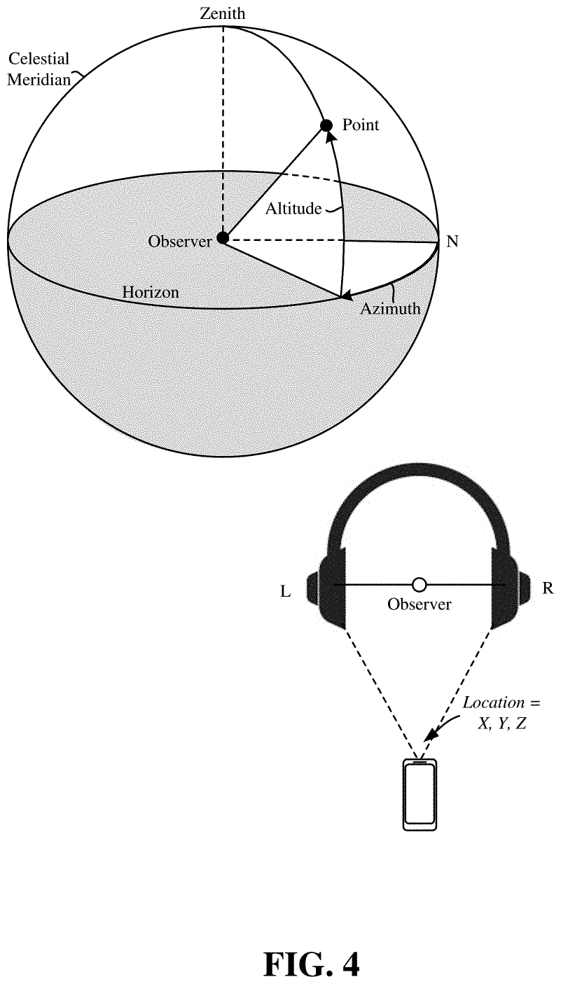

As represented in FIG. 4, with the left and right speaker locations known, an azimuth angle for the direction of view of the observer may be determined as the direction ninety degrees between the L and R points, measured clockwise from the left. This accounts for a determination of the azimuth angle for the observer looking straight ahead. The altitude angle may be determined using an electronic gyroscope such as a MEMS (microelectromechanical systems) gyroscope. By combining the determined azimuth and altitude, a direction of vision within a 360-degree space of the observer may be estimated.

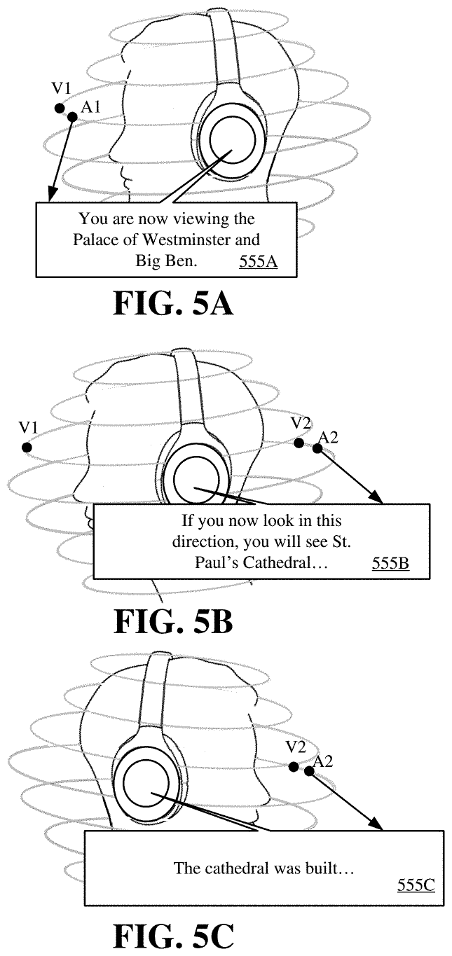

Turning to the mapping of the view direction to a spatial audio model, when the observer is looking ahead at a view as shown in FIG. 5A, the determined azimuth and altitude may be sent to a server (e.g., the server 106 of FIG. 1) or other such service. The server uses the azimuth and altitude data to determine a visual reference point V1 within or proximate a 360-degree spatial audio sphere model surrounding the user's head. Therefore a visual reference point is created within the spatial audio model.

Audio content may be presented to the user using the headphones. In the virtual or real-world guided tour example shown in FIG. 1, for instance, this content may be an audio narration that is descriptive of the view that the user is observing. This audio content (e.g., represented in FIG. 5A by block 555A) may be retrieved, for instance, from the audio content data store (database) 108 by the server 106. The server 106 adjusts the frequencies of the audio content 555A presented to both the left and right speakers so that the spatial audio can be produced such that the user perceives the sound as coming from a certain direction, which in FIG. 5A is represented by the direction A1 (the same or very close to V1) relative to the user.

The audio content may include timestamped metadata that includes location information for a second point of visual interest. This location information may be used in combination with the currently known point V1 to map the relative location V2 (FIG. 5B) to the spatial audio model for the user. That is, the user may be looking toward V1 but the next point of visual interest may be point V2, as indicated by the mapping of the metadata. The audio content (block 555B) can provide verbal guidance (e.g., “turn around”) as well as be presented as spatial audio that is perceived as coming from a direction generally or closely aligned with the point V2 (“if you look in this direction . . . ”). In a virtual gaming environment, a user's view can be directed based on the current game context, (e.g., “look out left, a villain is approaching!”)

To present further audio content for the second point of visual interest, the server retrieves (or has previously retrieved and communicated in anticipation of its need) the audio content associated with the next timestamped segment for the second point of interest V2, and if needed adjusts the frequencies of the audio content presented to both the left and right speakers such that the spatial audio produced is such that it sounds like it is coming from the direction A2 (the same as V2) relative to the user. In this way, as the user adjusts their orientation relative to V2, the server adjusts the spatial audio settings for the presentation of the audio for the duration of time that the metadata indicates that V2 is the visual point of interest such that V2 and A2 are in alignment. When aligned to within a threshold alignment criterion, e.g., ninety-five percent aligned, the next set of audio content (block 555C) can be output as represented in FIG. 5C.

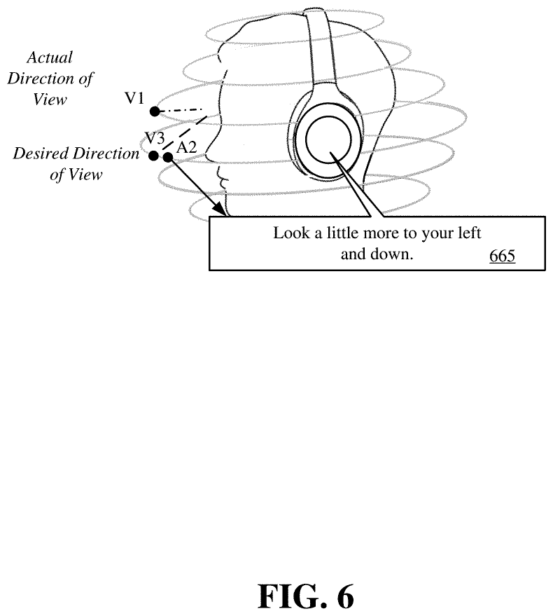

The technology described herein further facilitates adjusting audio content based on audio/visual alignment. The server 106 may continually or reasonably frequency monitor for audio and view alignment, e.g., via AX and VX transmissions. When AX and VX are not aligned, the server 106 may alter the audio content being presented to the user. In one example, the server 106 may pause playing the audio until the alignment is achieved, or until the alignment is within a threshold variation. In another example, the server may retrieve and insert audio cues that may be used to assist in AX/VX alignment, e.g., “Look a little more to your left and down.” as represented by the audio content shown in block 665 of FIG. 6. The content of the cue used may be based on the orientation of VX and AX and the orientation difference between them.

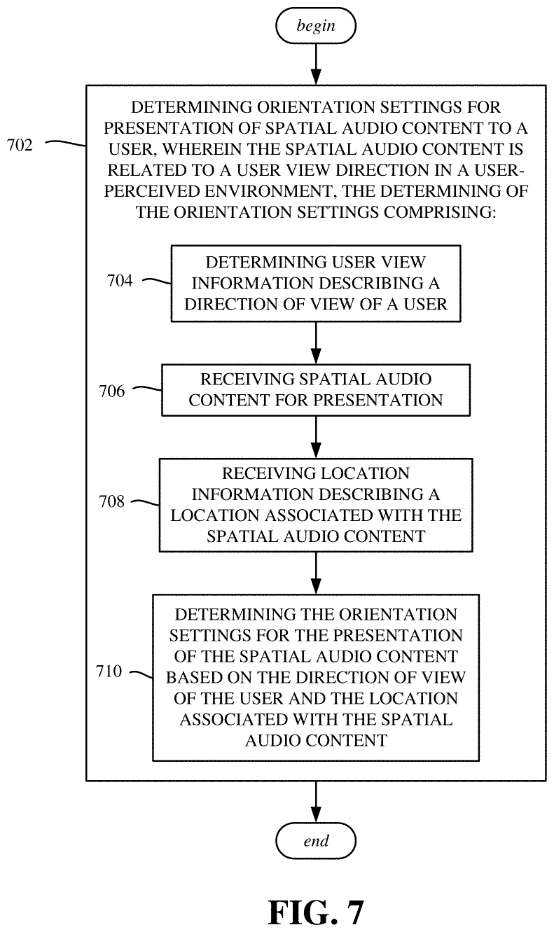

One or more example aspects are represented in FIG. 7, and can correspond to a system, including a processor, and a memory that stores executable instructions that, when executed by the processor, facilitate performance of operations. Example operation 702 represents determining orientation settings for presentation of spatial audio content to a user, wherein the spatial audio content is related to a user view direction in a user-perceived environment. Determining the orientation settings can include determining user view information describing a direction of view of a user (operation 704), receiving spatial audio content for presentation (operation 706), receiving location information describing a location associated with the spatial audio content (operation 708) and determining the orientation settings for the presentation of the spatial audio content based on the direction of view of the user and the location associated with the spatial audio content (operation 710).

Further operations can include determining user location information associated with the user, and wherein the determining of the orientation settings for the spatial audio content is further based on the user location information.

Further operations can include selecting a portion of the spatial audio content based on the direction of view of the user, and outputting the portion of the spatial audio content.

Further operations can include monitoring the direction of view of the user, determining, based on the monitoring, that the direction of view of the user has changed from a first direction of view to a second direction of view, and pausing output of the spatial audio content in response to the first direction being determined to have changed to the second direction of view of the user.

Further operations can include monitoring the direction of view of the user, determining, based on the monitoring, that the direction of view of the user is to change from a first direction of view to a second direction of view, and, in response to the determining that the direction of view of the user is to change, outputting guiding spatial audio that directs the user to change the direction of view of the user from the first direction of view to the second direction of view.

Further operations can include determining that the second direction of view of the user is aligned, within a threshold alignment criterion, with a position within the user-perceived environment corresponding to the second direction of view, and, in response to the determining that the second direction of view is aligned with the position, selecting a portion of the spatial audio content, and outputting the portion of the spatial audio content.

Outputting the guiding spatial audio that directs the user to change the direction of view of the user from the first direction of view to the second direction of view can include modifying the spatial audio orientation settings to output audio that is perceived by the user as originating from an audio source at a position within the user-perceived environment that corresponds to the second direction of view.

The perceived environment can be a real world environment, and the location information associated with the spatial audio content can include a real world location.

The perceived environment can be a virtual environment, and the location information associated with the spatial audio content can include a virtual environment location.

Further operations can include monitoring the direction of view of the user to determine a current direction of view of the user, and adjusting output of the spatial audio content based on the current direction of view of the user.

The direction of view of the user can be mapped to a spatial audio model.

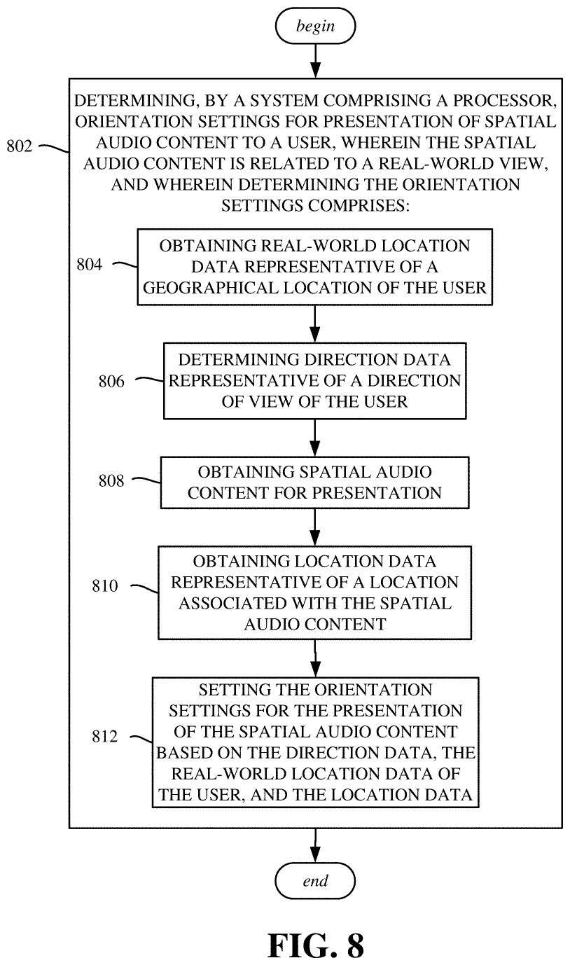

One or more example aspects are represented in FIG. 8, and, for example, can correspond to operations, such as of a method. Example operation 802 represents determining, by a system comprising a processor, orientation settings for presentation of spatial audio content to a user, wherein the spatial audio content is related to a real-world view. Determining the orientation settings can include obtaining real-world location data representative of a geographical location of the user (operation 804), determining direction data representative of a direction of view of the user (operation 806), obtaining spatial audio content for presentation (operation 808), obtaining location data representative of a location associated with the spatial audio content (operation 810), and setting the orientation settings for the presentation of the spatial audio content based on the direction data, the real-world location data of the user, and the location data (operation 812).

The direction of view can be a first direction of view, and further operations can include monitoring, by the system, the first direction of view of the user, determining, based on the monitoring, that the first direction of view of the user has changed from the first direction of view to a second direction of view, and modifying the orientation settings in response to the determining that the first direction of view of the user has changed to the second direction of view.

The geographical location can be a first geographical location, and further operations can include monitoring, by the system, the location data of the user, determining, based on the monitoring, that the first geographical location of the user has changed from the first geographical location to a second geographical location, and modifying the orientation settings in response to the determining that the location of the user has changed to the second geographical location.

The direction of view of the user can be a first direction of view, and further operations can include outputting, by the system, a first portion of the spatial audio content based on the first direction of view, determining, by the system, that the first direction of view has changed to a second direction of view, and, in response to the determining that the first direction of view has changed to the second direction of view, outputting, by the system, a second portion of the spatial audio content.

The direction of view of the user can be a first direction of view, and further operations can include outputting, by the system, guidance audio directing the user to change from the first direction of view to a second direction of view.

Guidance audio directing the user to change from the first direction of view to the second direction of view can include spatial audio that can be perceived by the user as originating from an audio source aligned with the second direction of view.

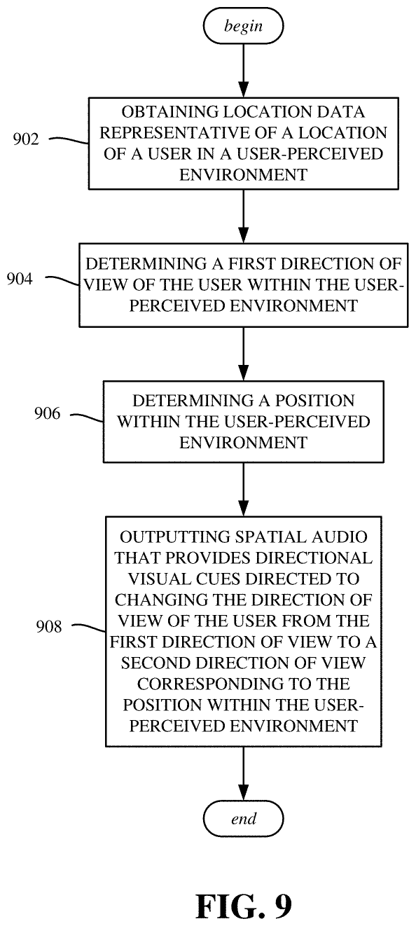

One or more aspects are represented in FIG. 9, such as implemented in a machine-readable medium, including executable instructions that, when executed by a processor, facilitate performance of operations. Example operation 902 represents obtaining location data representative of a location of a user in a user-perceived environment. Operation 904 represents determining a first direction of view of the user within the user-perceived environment. Operation 906 represents determining a position within the user-perceived environment. Operation 908 represents outputting spatial audio that provides directional visual cues directed to changing the direction of view of the user from the first direction of view to a second direction of view corresponding to the position within the user-perceived environment.

Outputting the spatial audio comprises determining orientation data for the spatial audio, based on the first direction of view of the user and the location data, to be perceived by the user as originating from an audio source proximate the position within the user-perceived environment.

The spatial audio that provides the directional visual cues can include first spatial audio, and further operations can include determining that the second direction of view is aligned, within a threshold alignment criterion, with the position within the user-perceived environment, and, in response to the determining that the second direction of view is aligned, outputting second spatial audio associated with the position within the user-perceived environment.

As can be seen, the technology described herein facilitates directing a user to view in a particular direction in a real-world or virtual environment. The view can be mapped to a real world geographic location or a virtual location in a virtual environment. The use of spatial audio can assist in the directing, and alignment with the desired direction can be monitored. Verbal cues as well as the perceived direction of the audio source via spatial audio can be used as guidance audio to guide a user's alignment.

Turning to aspects in general, a wireless communication system can employ various cellular systems, technologies, and modulation schemes to facilitate wireless radio communications between devices (e.g., a UE and the network equipment). While example embodiments might be described for 5G new radio (NR) systems, the embodiments can be applicable to any radio access technology (RAT) or multi-RAT system where the UE operates using multiple carriers e.g. LTE FDD/TDD, GSM/GERAN, CDMA2000 etc. For example, the system can operate in accordance with global system for mobile communications (GSM), universal mobile telecommunications service (UMTS), long term evolution (LTE), LTE frequency division duplexing (LTE FDD, LTE time division duplexing (TDD), high speed packet access (HSPA), code division multiple access (CDMA), wideband CDMA (WCMDA), CDMA2000, time division multiple access (TDMA), frequency division multiple access (FDMA), multi-carrier code division multiple access (MC-CDMA), single-carrier code division multiple access (SC-CDMA), single-carrier FDMA (SC-FDMA), orthogonal frequency division multiplexing (OFDM), discrete Fourier transform spread OFDM (DFT-spread OFDM) single carrier FDMA (SC-FDMA), Filter bank based multi-carrier (FBMC), zero tail DFT-spread-OFDM (ZT DFT-s-OFDM), generalized frequency division multiplexing (GFDM), fixed mobile convergence (FMC), universal fixed mobile convergence (UFMC), unique word OFDM (UW-OFDM), unique word DFT-spread OFDM (UW DFT-Spread-OFDM), cyclic prefix OFDM CP-OFDM, resource-block-filtered OFDM, Wi Fi, WLAN, WiMax, and the like. However, various features and functionalities of system are particularly described wherein the devices (e.g., the UEs and the network equipment) of the system are configured to communicate wireless signals using one or more multi carrier modulation schemes, wherein data symbols can be transmitted simultaneously over multiple frequency subcarriers (e.g., OFDM, CP-OFDM, DFT-spread OFDM, UFMC, FMBC, etc.). The embodiments are applicable to single carrier as well as to multicarrier (MC) or carrier aggregation (CA) operation of the UE. The term carrier aggregation (CA) is also called (e.g. interchangeably called) “multi-carrier system”, “multi-cell operation”, “multi-carrier operation”, “multi-carrier” transmission and/or reception. Note that some embodiments are also applicable for Multi RAB (radio bearers) on some carriers (that is data plus speech is simultaneously scheduled).

In various embodiments, the system can be configured to provide and employ 5G wireless networking features and functionalities. With 5G networks that may use waveforms that split the bandwidth into several sub-bands, different types of services can be accommodated in different sub-bands with the most suitable waveform and numerology, leading to improved spectrum utilization for 5G networks. Notwithstanding, in the mmWave spectrum, the millimeter waves have shorter wavelengths relative to other communications waves, whereby mmWave signals can experience severe path loss, penetration loss, and fading. However, the shorter wavelength at mmWave frequencies also allows more antennas to be packed in the same physical dimension, which allows for large-scale spatial multiplexing and highly directional beamforming.

Performance can be improved if both the transmitter and the receiver are equipped with multiple antennas. Multi-antenna techniques can significantly increase the data rates and reliability of a wireless communication system. The use of multiple input multiple output (MIMO) techniques, which was introduced in the third-generation partnership project (3GPP) and has been in use (including with LTE), is a multi-antenna technique that can improve the spectral efficiency of transmissions, thereby significantly boosting the overall data carrying capacity of wireless systems. The use of multiple-input multiple-output (MIMO) techniques can improve mmWave communications; MIMO can be used for achieving diversity gain, spatial multiplexing gain and beamforming gain.

Note that using multi-antennas does not always mean that MIMO is being used. For example, a configuration can have two downlink antennas, and these two antennas can be used in various ways. In addition to using the antennas in a 2×2 MIMO scheme, the two antennas can also be used in a diversity configuration rather than MIMO configuration. Even with multiple antennas, a particular scheme might only use one of the antennas (e.g., LTE specification's transmission mode 1, which uses a single transmission antenna and a single receive antenna). Or, only one antenna can be used, with various different multiplexing, precoding methods etc.

The MIMO technique uses a commonly known notation (M×N) to represent MIMO configuration in terms number of transmit (M) and receive antennas (N) on one end of the transmission system. The common MIMO configurations used for various technologies are: (2×1), (1×2), (2×2), (4×2), (8×2) and (2×4), (4×4), (8×4). The configurations represented by (2×1) and (1×2) are special cases of MIMO known as transmit diversity (or spatial diversity) and receive diversity. In addition to transmit diversity (or spatial diversity) and receive diversity, other techniques such as spatial multiplexing (including both open-loop and closed-loop), beamforming, and codebook-based precoding can also be used to address issues such as efficiency, interference, and range.

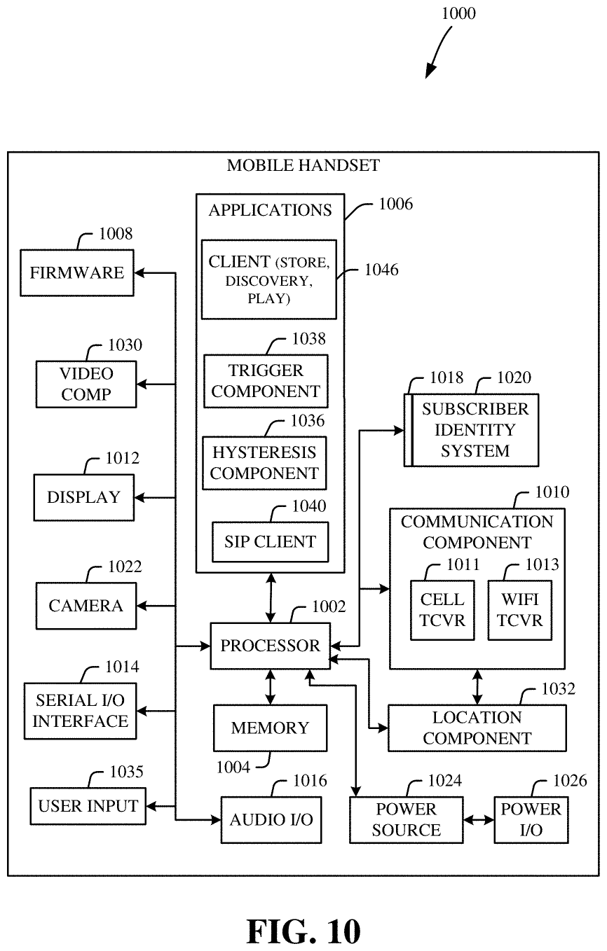

Referring now to FIG. 10, illustrated is a schematic block diagram of an example end-user device (such as user equipment) that can be a mobile device 1000 capable of connecting to a network in accordance with some embodiments described herein. Although a mobile handset 1000 is illustrated herein, it will be understood that other devices can be a mobile device, and that the mobile handset 1000 is merely illustrated to provide context for the embodiments of the various embodiments described herein. The following discussion is intended to provide a brief, general description of an example of a suitable environment 1000 in which the various embodiments can be implemented. While the description includes a general context of computer-executable instructions embodied on a machine-readable storage medium, those skilled in the art will recognize that the various embodiments also can be implemented in combination with other program modules and/or as a combination of hardware and software.

Generally, applications (e.g., program modules) can include routines, programs, components, data structures, etc., that perform particular tasks or implement particular abstract data types. Moreover, those skilled in the art will appreciate that the methods described herein can be practiced with other system configurations, including single-processor or multiprocessor systems, minicomputers, mainframe computers, as well as personal computers, hand-held computing devices, microprocessor-based or programmable consumer electronics, and the like, each of which can be operatively coupled to one or more associated devices.

A computing device can typically include a variety of machine-readable media. Machine-readable media can be any available media that can be accessed by the computer and includes both volatile and non-volatile media, removable and non-removable media. By way of example and not limitation, computer-readable media can include computer storage media and communication media. Computer storage media can include volatile and/or non-volatile media, removable and/or non-removable media implemented in any method or technology for storage of information, such as computer-readable instructions, data structures, program modules or other data. Computer storage media can include, but is not limited to, RAM, ROM, EEPROM, flash memory or other memory technology, CD ROM, digital video disk (DVD) or other optical disk storage, magnetic cassettes, magnetic tape, magnetic disk storage or other magnetic storage devices, or any other medium which can be used to store the desired information and which can be accessed by the computer.

Communication media typically embodies computer-readable instructions, data structures, program modules or other data in a modulated data signal such as a carrier wave or other transport mechanism, and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer-readable media.

The handset 1000 includes a processor 1002 for controlling and processing all onboard operations and functions. A memory 1004 interfaces to the processor 1002 for storage of data and one or more applications 1006 (e.g., a video player software, user feedback component software, etc.). Other applications can include voice recognition of predetermined voice commands that facilitate initiation of the user feedback signals. The applications 1006 can be stored in the memory 1004 and/or in a firmware 1008, and executed by the processor 1002 from either or both the memory 1004 or/and the firmware 1008. The firmware 1008 can also store startup code for execution in initializing the handset 1000. A communications component 1010 interfaces to the processor 1002 to facilitate wired/wireless communication with external systems, e.g., cellular networks, VoIP networks, and so on. Here, the communications component 1010 can also include a suitable cellular transceiver 1011 (e.g., a GSM transceiver) and/or an unlicensed transceiver 1013 (e.g., Wi-Fi, WiMax) for corresponding signal communications. The handset 1000 can be a device such as a cellular telephone, a PDA with mobile communications capabilities, and messaging-centric devices. The communications component 1010 also facilitates communications reception from terrestrial radio networks (e.g., broadcast), digital satellite radio networks, and Internet-based radio services networks.

The handset 1000 includes a display 1012 for displaying text, images, video, telephony functions (e.g., a Caller ID function), setup functions, and for user input. For example, the display 1012 can also be referred to as a “screen” that can accommodate the presentation of multimedia content (e.g., music metadata, messages, wallpaper, graphics, etc.). The display 1012 can also display videos and can facilitate the generation, editing and sharing of video quotes. A serial I/O interface 1014 is provided in communication with the processor 1002 to facilitate wired and/or wireless serial communications (e.g., USB, and/or IEEE 1094) through a hardwire connection, and other serial input devices (e.g., a keyboard, keypad, and mouse). This supports updating and troubleshooting the handset 1000, for example. Audio capabilities are provided with an audio I/O component 1016, which can include a speaker for the output of audio signals related to, for example, indication that the user pressed the proper key or key combination to initiate the user feedback signal. The audio I/O component 1016 also facilitates the input of audio signals through a microphone to record data and/or telephony voice data, and for inputting voice signals for telephone conversations.

The handset 1000 can include a slot interface 1018 for accommodating a SIC (Subscriber Identity Component) in the form factor of a card Subscriber Identity Module (SIM) or universal SIM 1020, and interfacing the SIM card 1020 with the processor 1002. However, it is to be appreciated that the SIM card 1020 can be manufactured into the handset 1000, and updated by downloading data and software.

The handset 1000 can process IP data traffic through the communication component 1010 to accommodate IP traffic from an IP network such as, for example, the Internet, a corporate intranet, a home network, a person area network, etc., through an ISP or broadband cable provider. Thus, VoIP traffic can be utilized by the handset 800 and IP-based multimedia content can be received in either an encoded or decoded format.

A video processing component 1022 (e.g., a camera) can be provided for decoding encoded multimedia content. The video processing component 1022 can aid in facilitating the generation, editing and sharing of video quotes. The handset 1000 also includes a power source 1024 in the form of batteries and/or an AC power subsystem, which power source 1024 can interface to an external power system or charging equipment (not shown) by a power I/O component 1026.

The handset 1000 can also include a video component 1030 for processing video content received and, for recording and transmitting video content. For example, the video component 1030 can facilitate the generation, editing and sharing of video quotes. A location tracking component 1032 facilitates geographically locating the handset 1000. As described hereinabove, this can occur when the user initiates the feedback signal automatically or manually. A user input component 1034 facilitates the user initiating the quality feedback signal. The user input component 1034 can also facilitate the generation, editing and sharing of video quotes. The user input component 1034 can include such conventional input device technologies such as a keypad, keyboard, mouse, stylus pen, and/or touch screen, for example.

Referring again to the applications 1006, a hysteresis component 1036 facilitates the analysis and processing of hysteresis data, which is utilized to determine when to associate with the access point. A software trigger component 1038 can be provided that facilitates triggering of the hysteresis component 1038 when the Wi-Fi transceiver 1013 detects the beacon of the access point. A SIP client 1040 enables the handset 1000 to support SIP protocols and register the subscriber with the SIP registrar server. The applications 1006 can also include a client 1042 that provides at least the capability of discovery, play and store of multimedia content, for example, music.

The handset 1000, as indicated above related to the communications component 810, includes an indoor network radio transceiver 1013 (e.g., Wi-Fi transceiver). This function supports the indoor radio link, such as IEEE 802.11, for the dual-mode GSM handset 1000. The handset 1000 can accommodate at least satellite radio services through a handset that can combine wireless voice and digital radio chipsets into a single handheld device.

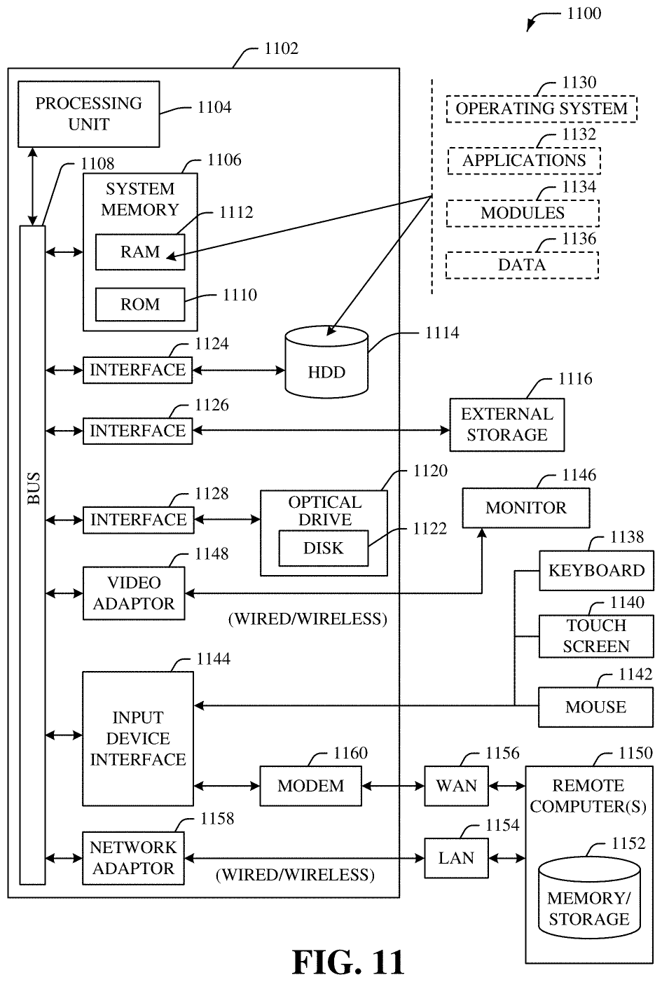

In order to provide additional context for various embodiments described herein, FIG. 11 and the following discussion are intended to provide a brief, general description of a suitable computing environment 1100 in which the various embodiments of the embodiment described herein can be implemented. While the embodiments have been described above in the general context of computer-executable instructions that can run on one or more computers, those skilled in the art will recognize that the embodiments can be also implemented in combination with other program modules and/or as a combination of hardware and software.

Generally, program modules include routines, programs, components, data structures, etc., that perform particular tasks or implement particular abstract data types. Moreover, those skilled in the art will appreciate that the various methods can be practiced with other computer system configurations, including single-processor or multiprocessor computer systems, minicomputers, mainframe computers, Internet of Things (IoT) devices, distributed computing systems, as well as personal computers, hand-held computing devices, microprocessor-based or programmable consumer electronics, and the like, each of which can be operatively coupled to one or more associated devices.

The illustrated embodiments of the embodiments herein can be also practiced in distributed computing environments where certain tasks are performed by remote processing devices that are linked through a communications network. In a distributed computing environment, program modules can be located in both local and remote memory storage devices.

Computing devices typically include a variety of media, which can include computer-readable storage media, machine-readable storage media, and/or communications media, which two terms are used herein differently from one another as follows. Computer-readable storage media or machine-readable storage media can be any available storage media that can be accessed by the computer and includes both volatile and nonvolatile media, removable and non-removable media. By way of example, and not limitation, computer-readable storage media or machine-readable storage media can be implemented in connection with any method or technology for storage of information such as computer-readable or machine-readable instructions, program modules, structured data or unstructured data.

Computer-readable storage media can include, but are not limited to, random access memory (RAM), read only memory (ROM), electrically erasable programmable read only memory (EEPROM), flash memory or other memory technology, compact disk read only memory (CD-ROM), digital versatile disk (DVD), Blu-ray disc (BD) or other optical disk storage, magnetic cassettes, magnetic tape, magnetic disk storage or other magnetic storage devices, solid state drives or other solid state storage devices, or other tangible and/or non-transitory media which can be used to store desired information. In this regard, the terms “tangible” or “non-transitory” herein as applied to storage, memory or computer-readable media, are to be understood to exclude only propagating transitory signals per se as modifiers and do not relinquish rights to all standard storage, memory or computer-readable media that are not only propagating transitory signals per se.

Computer-readable storage media can be accessed by one or more local or remote computing devices, e.g., via access requests, queries or other data retrieval protocols, for a variety of operations with respect to the information stored by the medium.

Communications media typically embody computer-readable instructions, data structures, program modules or other structured or unstructured data in a data signal such as a modulated data signal, e.g., a carrier wave or other transport mechanism, and includes any information delivery or transport media. The term “modulated data signal” or signals refers to a signal that has one or more of its characteristics set or changed in such a manner as to encode information in one or more signals. By way of example, and not limitation, communication media include wired media, such as a wired network or direct-wired connection, and wireless media such as acoustic, RF, infrared and other wireless media.

With reference again to FIG. 11, the example environment 1100 for implementing various embodiments of the aspects described herein includes a computer 1102, the computer 1102 including a processing unit 1104, a system memory 1106 and a system bus 1108. The system bus 1108 couples system components including, but not limited to, the system memory 1106 to the processing unit 1104. The processing unit 1104 can be any of various commercially available processors. Dual microprocessors and other multi-processor architectures can also be employed as the processing unit 1104.

The system bus 1108 can be any of several types of bus structure that can further interconnect to a memory bus (with or without a memory controller), a peripheral bus, and a local bus using any of a variety of commercially available bus architectures. The system memory 1106 includes ROM 1110 and RAM 1112. A basic input/output system (BIOS) can be stored in a non-volatile memory such as ROM, erasable programmable read only memory (EPROM), EEPROM, which BIOS contains the basic routines that help to transfer information between elements within the computer 1102, such as during startup. The RAM 1112 can also include a high-speed RAM such as static RAM for caching data.

The computer 1102 further includes an internal hard disk drive (HDD) 1114 (e.g., EIDE, SATA), one or more external storage devices 1116 (e.g., a magnetic floppy disk drive (FDD) 1116, a memory stick or flash drive reader, a memory card reader, etc.) and an optical disk drive 1120 (e.g., which can read or write from a CD-ROM disc, a DVD, a BD, etc.). While the internal HDD 1114 is illustrated as located within the computer 1102, the internal HDD 1114 can also be configured for external use in a suitable chassis (not shown). Additionally, while not shown in environment 1100, a solid state drive (SSD), non-volatile memory and other storage technology could be used in addition to, or in place of, an HDD 1114, and can be internal or external. The HDD 1114, external storage device(s) 1116 and optical disk drive 1120 can be connected to the system bus 1108 by an HDD interface 1124, an external storage interface 1126 and an optical drive interface 1128, respectively. The interface 1124 for external drive implementations can include at least one or both of Universal Serial Bus (USB) and Institute of Electrical and Electronics Engineers (IEEE) 1094 interface technologies. Other external drive connection technologies are within contemplation of the embodiments described herein.

The drives and their associated computer-readable storage media provide nonvolatile storage of data, data structures, computer-executable instructions, and so forth. For the computer 1102, the drives and storage media accommodate the storage of any data in a suitable digital format. Although the description of computer-readable storage media above refers to respective types of storage devices, it should be appreciated by those skilled in the art that other types of storage media which are readable by a computer, whether presently existing or developed in the future, could also be used in the example operating environment, and further, that any such storage media can contain computer-executable instructions for performing the methods described herein.

A number of program modules can be stored in the drives and RAM 1112, including an operating system 1130, one or more application programs 1132, other program modules 1134 and program data 1136. All or portions of the operating system, applications, modules, and/or data can also be cached in the RAM 1112. The systems and methods described herein can be implemented utilizing various commercially available operating systems or combinations of operating systems.

Computer 1102 can optionally include emulation technologies. For example, a hypervisor (not shown) or other intermediary can emulate a hardware environment for operating system 1130, and the emulated hardware can optionally be different from the hardware illustrated in FIG. 11. In such an embodiment, operating system 1130 can include one virtual machine (VM) of multiple VMs hosted at computer 1102. Furthermore, operating system 1130 can provide runtime environments, such as the Java runtime environment or the .NET framework, for applications 1132. Runtime environments are consistent execution environments that allow applications 1132 to run on any operating system that includes the runtime environment. Similarly, operating system 1130 can support containers, and applications 1132 can be in the form of containers, which are lightweight, standalone, executable packages of software that include, e.g., code, runtime, system tools, system libraries and settings for an application.

Further, computer 1102 can be enabled with a security module, such as a trusted processing module (TPM). For instance with a TPM, boot components hash next in time boot components, and wait for a match of results to secured values, before loading a next boot component. This process can take place at any layer in the code execution stack of computer 1102, e.g., applied at the application execution level or at the operating system (OS) kernel level, thereby enabling security at any level of code execution.

A user can enter commands and information into the computer 1102 through one or more wired/wireless input devices, e.g., a keyboard 1138, a touch screen 1140, and a pointing device, such as a mouse 1142. Other input devices (not shown) can include a microphone, an infrared (IR) remote control, a radio frequency (RF) remote control, or other remote control, a joystick, a virtual reality controller and/or virtual reality headset, a game pad, a stylus pen, an image input device, e.g., camera(s), a gesture sensor input device, a vision movement sensor input device, an emotion or facial detection device, a biometric input device, e.g., fingerprint or iris scanner, or the like. These and other input devices are often connected to the processing unit 1104 through an input device interface 1144 that can be coupled to the system bus 1108, but can be connected by other interfaces, such as a parallel port, an IEEE 1094 serial port, a game port, a USB port, an IR interface, a BLUETOOTH® interface, etc.

A monitor 1146 or other type of display device can be also connected to the system bus 1108 via an interface, such as a video adapter 1148. In addition to the monitor 1146, a computer typically includes other peripheral output devices (not shown), such as speakers, printers, etc.

The computer 1102 can operate in a networked environment using logical connections via wired and/or wireless communications to one or more remote computers, such as a remote computer(s) 1150. The remote computer(s) 1150 can be a workstation, a server computer, a router, a personal computer, portable computer, microprocessor-based entertainment appliance, a peer device or other common network node, and typically includes many or all of the elements described relative to the computer 1102, although, for purposes of brevity, only a memory/storage device 1152 is illustrated. The logical connections depicted include wired/wireless connectivity to a local area network (LAN) 1154 and/or larger networks, e.g., a wide area network (WAN) 1156. Such LAN and WAN networking environments are commonplace in offices and companies, and facilitate enterprise-wide computer networks, such as intranets, all of which can connect to a global communications network, e.g., the Internet.

When used in a LAN networking environment, the computer 1102 can be connected to the local network 1154 through a wired and/or wireless communication network interface or adapter 1158. The adapter 1158 can facilitate wired or wireless communication to the LAN 1154, which can also include a wireless access point (AP) disposed thereon for communicating with the adapter 1158 in a wireless mode.

When used in a WAN networking environment, the computer 1102 can include a modem 1160 or can be connected to a communications server on the WAN 1156 via other means for establishing communications over the WAN 1156, such as by way of the Internet. The modem 1160, which can be internal or external and a wired or wireless device, can be connected to the system bus 1108 via the input device interface 1144. In a networked environment, program modules depicted relative to the computer 1102 or portions thereof, can be stored in the remote memory/storage device 1152. It will be appreciated that the network connections shown are example and other means of establishing a communications link between the computers can be used.

When used in either a LAN or WAN networking environment, the computer 1102 can access cloud storage systems or other network-based storage systems in addition to, or in place of, external storage devices 1116 as described above. Generally, a connection between the computer 1102 and a cloud storage system can be established over a LAN 1154 or WAN 1156 e.g., by the adapter 1158 or modem 1160, respectively. Upon connecting the computer 1102 to an associated cloud storage system, the external storage interface 1126 can, with the aid of the adapter 1158 and/or modem 1160, manage storage provided by the cloud storage system as it would other types of external storage. For instance, the external storage interface 1126 can be configured to provide access to cloud storage sources as if those sources were physically connected to the computer 1102.

The computer 1102 can be operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, store shelf, etc.), and telephone. This can include Wireless Fidelity (Wi-Fi) and BLUETOOTH® wireless technologies. Thus, the communication can be a predefined structure as with a conventional network or simply an ad hoc communication between at least two devices.

The computer is operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, restroom), and telephone. This includes at least Wi-Fi and Bluetooth™ wireless technologies. Thus, the communication can be a predefined structure as with a conventional network or simply an ad hoc communication between at least two devices.

Wi-Fi, or Wireless Fidelity, allows connection to the Internet from a couch at home, a bed in a hotel room, or a conference room at work, without wires. Wi-Fi is a wireless technology similar to that used in a cell phone that enables such devices, e.g., computers, to send and receive data indoors and out; anywhere within the range of a base station. Wi-Fi networks use radio technologies called IEEE802.11 (a, b, g, n, etc.) to provide secure, reliable, fast wireless connectivity. A Wi-Fi network can be used to connect computers to each other, to the Internet, and to wired networks (which use IEEE802.3 or Ethernet). Wi-Fi networks operate in the unlicensed 2.4 and 8 GHz radio bands, at an 11 Mbps (802.11b) or 84 Mbps (802.11a) data rate, for example, or with products that contain both bands (dual band), so the networks can provide real-world performance similar to the basic “10BaseT” wired Ethernet networks used in many offices.

As it employed in the subject specification, the term “processor” can refer to substantially any computing processing unit or device comprising, but not limited to comprising, single-core processors; single-processors with software multithread execution capability; multi-core processors; multi-core processors with software multithread execution capability; multi-core processors with hardware multithread technology; parallel platforms; and parallel platforms with distributed shared memory. Additionally, a processor can refer to an integrated circuit, an application specific integrated circuit (ASIC), a digital signal processor (DSP), a field programmable gate array (FPGA), a programmable logic controller (PLC), a complex programmable logic device (CPLD), a discrete gate or transistor logic, discrete hardware components, or any combination thereof designed to perform the functions described herein. Processors can exploit nano-scale architectures such as, but not limited to, molecular and quantum-dot based transistors, switches and gates, in order to optimize space usage or enhance performance of user equipment. A processor also can be implemented as a combination of computing processing units.

In the subject specification, terms such as “store,” “data store,” “data storage,” “database,” “repository,” “queue”, and substantially any other information storage component relevant to operation and functionality of a component, refer to “memory components,” or entities embodied in a “memory” or components comprising the memory. It will be appreciated that the memory components described herein can be either volatile memory or nonvolatile memory, or can include both volatile and nonvolatile memory. In addition, memory components or memory elements can be removable or stationary. Moreover, memory can be internal or external to a device or component, or removable or stationary. Memory can include various types of media that are readable by a computer, such as hard-disc drives, zip drives, magnetic cassettes, flash memory cards or other types of memory cards, cartridges, or the like.

By way of illustration, and not limitation, nonvolatile memory can include read only memory (ROM), programmable ROM (PROM), electrically programmable ROM (EPROM), electrically erasable ROM (EEPROM), or flash memory. Volatile memory can include random access memory (RAM), which acts as external cache memory. By way of illustration and not limitation, RAM is available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM). Additionally, the disclosed memory components of systems or methods herein are intended to include, without being limited, these and any other suitable types of memory.

In particular and in regard to the various functions performed by the above described components, devices, circuits, systems and the like, the terms (including a reference to a “means”) used to describe such components are intended to correspond, unless otherwise indicated, to any component which performs the specified function of the described component (e.g., a functional equivalent), even though not structurally equivalent to the disclosed structure, which performs the function in the herein illustrated example aspects of the embodiments. In this regard, it will also be recognized that the embodiments include a system as well as a computer-readable medium having computer-executable instructions for performing the acts and/or events of the various methods.

Computing devices typically include a variety of media, which can include computer-readable storage media and/or communications media, which two terms are used herein differently from one another as follows. Computer-readable storage media can be any available storage media that can be accessed by the computer and includes both volatile and nonvolatile media, removable and non-removable media. By way of example, and not limitation, computer-readable storage media can be implemented in connection with any method or technology for storage of information such as computer-readable instructions, program modules, structured data, or unstructured data.

Computer-readable storage media can include, but are not limited to, random access memory (RAM), read only memory (ROM), electrically erasable programmable read only memory (EEPROM), flash memory or other memory technology, solid state drive (SSD) or other solid-state storage technology, compact disk read only memory (CD ROM), digital versatile disk (DVD), Blu-ray disc or other optical disk storage, magnetic cassettes, magnetic tape, magnetic disk storage or other magnetic storage devices or other tangible and/or non-transitory media which can be used to store desired information.

In this regard, the terms “tangible” or “non-transitory” herein as applied to storage, memory or computer-readable media, are to be understood to exclude only propagating transitory signals per se as modifiers and do not relinquish rights to all standard storage, memory or computer-readable media that are not only propagating transitory signals per se. Computer-readable storage media can be accessed by one or more local or remote computing devices, e.g., via access requests, queries or other data retrieval protocols, for a variety of operations with respect to the information stored by the medium.

On the other hand, communications media typically embody computer-readable instructions, data structures, program modules or other structured or unstructured data in a data signal such as a modulated data signal, e.g., a carrier wave or other transport mechanism, and includes any information delivery or transport media. The term “modulated data signal” or signals refers to a signal that has one or more of its characteristics set or changed in such a manner as to encode information in one or more signals. By way of example, and not limitation, communications media include wired media, such as a wired network or direct-wired connection, and wireless media such as acoustic, RF, infrared and other wireless media

Further, terms like “user equipment,” “user device,” “mobile device,” “mobile,” station,” “access terminal,” “terminal,” “handset,” and similar terminology, generally refer to a wireless device utilized by a subscriber or user of a wireless communication network or service to receive or convey data, control, voice, video, sound, gaming, or substantially any data-stream or signaling-stream. The foregoing terms are utilized interchangeably in the subject specification and related drawings. Likewise, the terms “access point,” “node B,” “base station,” “evolved Node B,” “cell,” “cell site,” and the like, can be utilized interchangeably in the subject application, and refer to a wireless network component or appliance that serves and receives data, control, voice, video, sound, gaming, or substantially any data-stream or signaling-stream from a set of subscriber stations. Data and signaling streams can be packetized or frame-based flows. It is noted that in the subject specification and drawings, context or explicit distinction provides differentiation with respect to access points or base stations that serve and receive data from a mobile device in an outdoor environment, and access points or base stations that operate in a confined, primarily indoor environment overlaid in an outdoor coverage area. Data and signaling streams can be packetized or frame-based flows.

Furthermore, the terms “user,” “subscriber,” “customer,” “consumer,” and the like are employed interchangeably throughout the subject specification, unless context warrants particular distinction(s) among the terms. It should be appreciated that such terms can refer to human entities, associated devices, or automated components supported through artificial intelligence (e.g., a capacity to make inference based on complex mathematical formalisms) which can provide simulated vision, sound recognition and so forth. In addition, the terms “wireless network” and “network” are used interchangeable in the subject application, when context wherein the term is utilized warrants distinction for clarity purposes such distinction is made explicit.

Moreover, the word “exemplary” is used herein to mean serving as an example, instance, or illustration. Any aspect or design described herein as “exemplary” is not necessarily to be construed as preferred or advantageous over other aspects or designs. Rather, use of the word exemplary is intended to present concepts in a concrete fashion. As used in this application, the term “or” is intended to mean an inclusive “or” rather than an exclusive “or”. That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

In addition, while a particular feature may have been disclosed with respect to only one of several implementations, such feature may be combined with one or more other features of the other implementations as may be desired and advantageous for any given or particular application. Furthermore, to the extent that the terms “includes” and “including” and variants thereof are used in either the detailed description or the claims, these terms are intended to be inclusive in a manner similar to the term “comprising.”

The above descriptions of various embodiments of the subject disclosure and corresponding figures and what is described in the Abstract, are described herein for illustrative purposes, and are not intended to be exhaustive or to limit the disclosed embodiments to the precise forms disclosed. It is to be understood that one of ordinary skill in the art may recognize that other embodiments having modifications, permutations, combinations, and additions can be implemented for performing the same, similar, alternative, or substitute functions of the disclosed subject matter, and are therefore considered within the scope of this disclosure. Therefore, the disclosed subject matter should not be limited to any single embodiment described herein, but rather should be construed in breadth and scope in accordance with the claims below.

What is claimed is:

1. A system, comprising:
a processor; and
a memory that stores executable instructions that, when executed by the processor of the system, facilitate performance of operations, the operations comprising:
determining orientation settings for presentation of spatial audio content to a user, wherein the spatial audio content is related to a user view direction in a user-perceived environment, the determining of the orientation settings comprising:
determining user view information describing a direction of view of a user;
receiving spatial audio content for presentation;
receiving location information describing a location associated with the spatial audio content; and
determining the orientation settings for the presentation of the spatial audio content based on the direction of view of the user and the location associated with the spatial audio content.

2. The system of claim 1, wherein the operations further comprise determining user location information associated with the user, and wherein the determining of the orientation settings for the spatial audio content is further based on the user location information.

3. The system of claim 1, wherein the operations further comprise selecting a portion of the spatial audio content based on the direction of view of the user, and outputting the portion of the spatial audio content.

4. The system of claim 3, wherein the operations further comprise monitoring the direction of view of the user, determining, based on the monitoring, that the direction of view of the user has changed from a first direction of view to a second direction of view, and pausing output of the spatial audio content in response to the first direction being determined to have changed to the second direction of view of the user.

5. The system of claim 1, wherein the operations further comprise monitoring the direction of view of the user, determining, based on the monitoring, that the direction of view of the user is to change from a first direction of view to a second direction of view, and, in response to the determining that the direction of view of the user is to change, outputting guiding spatial audio that directs the user to change the direction of view of the user from the first direction of view to the second direction of view.

6. The system of claim 5, wherein the operations further comprise determining that the second direction of view of the user is aligned, within a threshold alignment criterion, with a position within the user-perceived environment corresponding to the second direction of view, and, in response to the determining that the second direction of view is aligned with the position, selecting a portion of the spatial audio content, and outputting the portion of the spatial audio content.

7. The system of claim 5, wherein outputting the guiding spatial audio that directs the user to change the direction of view of the user from the first direction of view to the second direction of view comprises modifying the spatial audio orientation settings to output audio that is perceived by the user as originating from an audio source at a position within the user-perceived environment that corresponds to the second direction of view.

8. The system of claim 1, wherein the perceived environment is a real world environment, and wherein the location information associated with the spatial audio content comprises a real world location.

9. The system of claim 1, wherein the perceived environment is a virtual environment, and wherein the location information associated with the spatial audio content comprises a virtual environment location.

10. The system of claim 1, wherein the operations further comprise monitoring the direction of view of the user to determine a current direction of view of the user, and adjusting output of the spatial audio content based on the current direction of view of the user.

11. The system of claim 1, wherein the direction of view of the user is mapped to a spatial audio model.

12. A method, comprising:
determining, by a system comprising a processor, orientation settings for presentation of spatial audio content to a user, wherein the spatial audio content is related to a real-world view, and wherein determining the orientation settings comprises:
obtaining real-world location data representative of a geographical location of the user;
determining direction data representative of a direction of view of the user;
obtaining spatial audio content for presentation;
obtaining location data representative of a location associated with the spatial audio content; and
setting the orientation settings for the presentation of the spatial audio content based on the direction data, the real-world location data of the user, and the location data.

13. The method of claim 12, wherein the direction of view is a first direction of view, and further comprising monitoring, by the system, the first direction of view of the user, determining, based on the monitoring, that the first direction of view of the user has changed from the first direction of view to a second direction of view, and modifying the orientation settings in response to the determining that the first direction of view of the user has changed to the second direction of view.

14. The method of claim 12, wherein the geographical location is a first geographical location, and further comprising monitoring, by the system, the location data of the user, determining, based on the monitoring, that the first geographical location of the user has changed from the first geographical location to a second geographical location, and modifying the orientation settings in response to the determining that the location of the user has changed to the second geographical location.

15. The method of claim 12, wherein the direction of view of the user is a first direction of view, and further comprising outputting, by the system, a first portion of the spatial audio content based on the first direction of view, determining, by the system, that the first direction of view has changed to a second direction of view, and, in response to the determining that the first direction of view has changed to the second direction of view, outputting, by the system, a second portion of the spatial audio content.

16. The method of claim 12, wherein the direction of view of the user is a first direction of view, and further comprising outputting, by the system, guidance audio directing the user to change from the first direction of view to a second direction of view.

17. The method of claim 16, wherein the guidance audio directing the user to change from the first direction of view to the second direction of view comprises spatial audio that is perceived by the user as originating from an audio source aligned with the second direction of view.

18. A non-transitory machine-readable medium, comprising executable instructions that, when executed by a processor, facilitate performance of operations, the operations comprising:
obtaining location data representative of a location of a user in a user-perceived environment;
determining a first direction of view of the user within the user-perceived environment;
determining a position within the user-perceived environment; and
outputting spatial audio that provides directional visual cues directed to changing the direction of view of the user from the first direction of view to a second direction of view corresponding to the position within the user-perceived environment.

19. The non-transitory machine-readable medium of claim 18, wherein outputting the spatial audio comprises determining orientation data for the spatial audio, based on the first direction of view of the user and the location data, to be perceived by the user as originating from an audio source proximate the position within the user-perceived environment.

20. The non-transitory machine-readable medium of claim 18, wherein the spatial audio that provides the directional visual cues comprises first spatial audio, and wherein the operations further comprise determining that the second direction of view is aligned, within a threshold alignment criterion, with the position within the user-perceived environment, and, in response to the determining that the second direction of view is aligned, outputting second spatial audio associated with the position within the user-perceived environment.
